(19) United States
(12) Patent Application Publication
(10) Pub. No.: US 2015/0186037 A1
(43) Pub. Date: Jul. 2, 2015

(54) INFORMATION PROCESSING DEVICE, INFORMATION PROCESSING DEVICE CONTROL METHOD, CONTROL PROGRAM, AND COMPUTER-READABLE RECORDING MEDIUM

(71) Applicant: SHARP KABUSHIKI KAISHA, Osaka-shi, Osaka (JP)

(72) Inventors: Toshiki Kanatani, Osaka-shi (JP); Yoshihiko Shiba, Osaka-shi (JP); Noriaki Yusa, Osaka-shi (JP); Kenichi Ishitobi, Osaka-shi (JP); Takeshi Yarita, Osaka-shi (JP)

(73) Assignee: SHARP KABUSHIKI KAISHA, Osaka-shi, Osaka (JP)

(21) Appl. No.: 14/412,299

(22) PCT Filed: Jul. 5, 2013
(86) PCT No.: PCT/JP2013/068550

§ 371 Date: Dec. 31, 2014

(30) Foreign Application Priority Data
Jul. 6, 2012 (JP) 2012-153097
Jul. 4, 2013 (JP) 2013-141112

(51) Int. Cl. G06F 3/0488

(52) U.S. Cl. CPC G06F 3/04886

(57) ABSTRACT

A virtual input device, which has a user-friendly representation, is to be displayed on a touch screen display by simple operation.

An information processing device 1 includes: a specified point obtaining section (21) for obtaining two specified points specified on the touch screen display (2); and a representation determining section (22) for determining a size, a location, and a direction of the virtual input device such that two reference points, which are assigned to the virtual input device in advance, match the respective two specified points.

### TECHNICAL FIELD

The present invention relates to (i) an information processing device which includes a touch screen display capable of displaying a virtual input device, (ii) a method of controlling the information processing device (control method), (iii) a control program, and (iv) a computer-readable storage medium (computer-readable recording medium).

### BACKGROUND ART

Along with an increase in prevalence of touch-panel-operated electronic devices such as smartphones, there have been introduced large-size display devices equipped with touch panels, such as the cases of electronic blackboards and video conference systems. In recent years, particularly, television receivers and digital signages, which include large-size touch screen displays exceeding 80 inches in size, have made their appearance in the market. Meanwhile, a technology has been developed, which enables a touch screen display to display a virtual keyboard that (i) has a size corresponding the size of a user's hands placed on the touch screen display, (ii) includes a plurality of virtual keys, and outputs code data of the plurality of virtual keys.

For example, Patent Literature 1 discloses an information processing device which (i) detects a size of a user's hands placed on a touch screen display and (ii) displays a virtual keyboard having a size corresponding to the size thus detected. Specifically, the information processing device includes: a touch screen display; a detecting section for detecting, in response to a detection signal transmitted from the touch screen display, a size of a user's hands placed on the touch screen display; a display section for displaying, on the touch screen display, a virtual keyboard that (a) includes a plurality of virtual keys via which respective key codes are to be inputted and (b) has a size corresponding to the size thus detected by the detecting section; and an outputting section for outputting code data that corresponds to an operated one of the plurality of virtual keys in the virtual keyboard.

### CITATION LIST

### Patent Literature

[Patent Literature 1]

Japanese Patent Application Publication, Tokukai, No. 2011-159089 (Publication Date: Aug. 18, 2011)

### SUMMARY OF INVENTION

### Technical Problem

However, the conventional configuration described above requires, before an input operation is initiated, several steps of operation such as “displaying a keyboard”, “moving the keyboard”, and “adjusting a size of the keyboard.” This poses a problem of impairing operation efficiency. Specifically, the information processing device disclosed in Patent Literature 1 requires both hands of a user for the detection of the size of the user's hands, that is, the information processing device needs to recognize a total of 10 points on the touch panel.

Lately, cases of a plurality of users simultaneously operating a touch panel have also been contemplated. This requires an improvement in operability. However, the conventional configuration described above does not take such a case into account.

The present invention has been made in view of the problem, and it is an object of the present invention to realize an information processing device, an information processing device control method, a control program, and a computer-readable storage medium, all of which are capable of allowing a virtual input device having user-friendly representation to be displayed on a touch screen display by simple operation.

### Solution to Problem

In order to attain the object, an information processing device of the present invention includes: a touch screen display for displaying a virtual input device via which a user carries out an input operation; a specified point obtaining section for obtaining two specified points specified on the touch screen display; a representation determining section for determining a size and a location of the virtual input device on the touch screen display such that two reference points, which are assigned to the virtual input device in advance, match the respective two specified points thus obtained by the specified point obtaining section; and a virtual input device display section for causing the virtual input device having the size and the location thus determined by the representation determining section to be displayed on the touch screen display.

In order to attain the object, an information processing device control method of the present invention is a method of controlling an information processing device including: a touch screen display for displaying a virtual input device via which a user carries out an input operation, said method including the steps of: (a) obtaining two specified points specified on the touch screen display; (b) determining a size and a location of the virtual input device on the touch screen display such that two reference points, which are assigned to the virtual input device in advance, match the respective two specified points thus obtained in the step (a); and (c) causing the virtual input device having the size and the location thus determined in the step (b) to be displayed on the touch screen display.

### Effects of Invention

As has been described, an information processing device of the present invention includes: a specified point obtaining section for obtaining two specified points specified on the touch screen display; a representation determining section for determining a size and a location of the virtual input device on the touch screen display such that two reference points, which are assigned to the virtual input device in advance, match the respective two specified points thus obtained by the specified point obtaining section; and a virtual input device display section for causing the virtual input device having the size and the location thus determined by the representation determining section to be displayed on the touch screen display.

An information processing device control method of the present invention is a method includes the steps of: (a) obtaining two specified points specified on a touch screen display; (b) determining a size and a location of a virtual input device on the touch screen display such that two reference points, which are assigned to the virtual input device in advance, match the respective two specified points thus obtained in the step (a); and (c) causing the virtual input device having the size and the location thus determined in the step (b) to be displayed on the touch screen display.

With the configuration, when a user specifies two specified points on the touch screen display so as to cause a virtual input device, which is desirably located and sized, to be displayed, a virtual input device having such representation is displayed.

Therefore, such an advantageous effect is produced that a user can cause a virtual input device, which is located and sized in a user-friendly manner, to be displayed by such simple operation as specifying two specified points on a touch screen display.

### BRIEF DESCRIPTION OF DRAWINGS

FIG. 1 is a functional diagram schematically illustrating a configuration of an information processing device in accordance with an embodiment of the present invention.

FIG. 2 is an explanatory view illustrating an external appearance of a touch screen display included in the information processing device illustrated in FIG. 1.

FIG. 3 is a set of views (a) through (c) schematically illustrating a method of setting a virtual keyboard to be displayed by the information processing device illustrated in FIG. 1.

FIG. 4 is an explanatory view illustrating two reference points assigned to a virtual keyboard displayed by the information processing device illustrated in FIG. 1.

FIG. 5 is a table illustrating a setting table which is stored in a setting table storage section included in the information processing device illustrated in FIG. 1.

FIG. 6 is a flow chart illustrating a flow of a process in which a virtual input device is displayed by the information processing device illustrated in FIG. 1.

FIG. 7 is a set of explanatory views (a) and (b) each illustrating a virtual input device, other than a virtual keyboard, displayed by the information processing device illustrated in FIG. 1, (a) of FIG. 7 illustrating a virtual numeric keypad and (b) of FIG. 7 illustrating a virtual touch pad.

FIG. 8 is an explanatory view illustrating a method of selecting, from a plurality of types of virtual input devices, a virtual input device to be displayed in the information processing device illustrated in FIG. 1.

FIG. 9 is a flow chart illustrating a flow of a process in which a virtual input device is selected from a plurality of types of virtual input devices in the information processing device illustrated in FIG. 1.

FIG. 10 is a set of explanatory views (a) through (c) illustrating patterns of an application image when the information processing device illustrated in FIG. 1 displays a virtual keyboard.

FIG. 11 is a set of explanatory views (a) through (c) illustrating representations of a virtual keyboard displayed by the information processing device illustrated in FIG. 1.

FIG. 12 is an explanatory view showing an example of how a virtual keyboard is displayed on a touch screen display in accordance with Modification 1 of the present invention.

FIG. 13 is a set of explanatory views (a) and (b) each showing an example of how a virtual keyboard is displayed on a touch screen display in accordance with Modification 3 of the present invention.

FIG. 14 is a set of explanatory views (a) through (c) each showing an example of how a virtual keyboard is displayed on a touch screen display in accordance with Modification 3 of the present invention.

FIG. 15 is a set of explanatory views (a) and (b) each showing an example of how virtual keyboard is displayed on a touch screen display in accordance with Modification 3 of the present invention.

FIG. 16 is a set of explanatory views (a) and (b) each showing an example of how a virtual keyboard is displayed on a touch screen display in accordance with Modification 3 of the present invention.

FIG. 17 is an explanatory view showing an example of how an image is displayed on a touch screen display while a character(s) is being inputted via a given virtual keyboard.

FIG. 18 is an explanatory view showing an example of how an image is displayed on a touch screen display while a character(s) is being inputted via a given virtual keyboard.

### DESCRIPTION OF EMBODIMENTS

### Embodiment

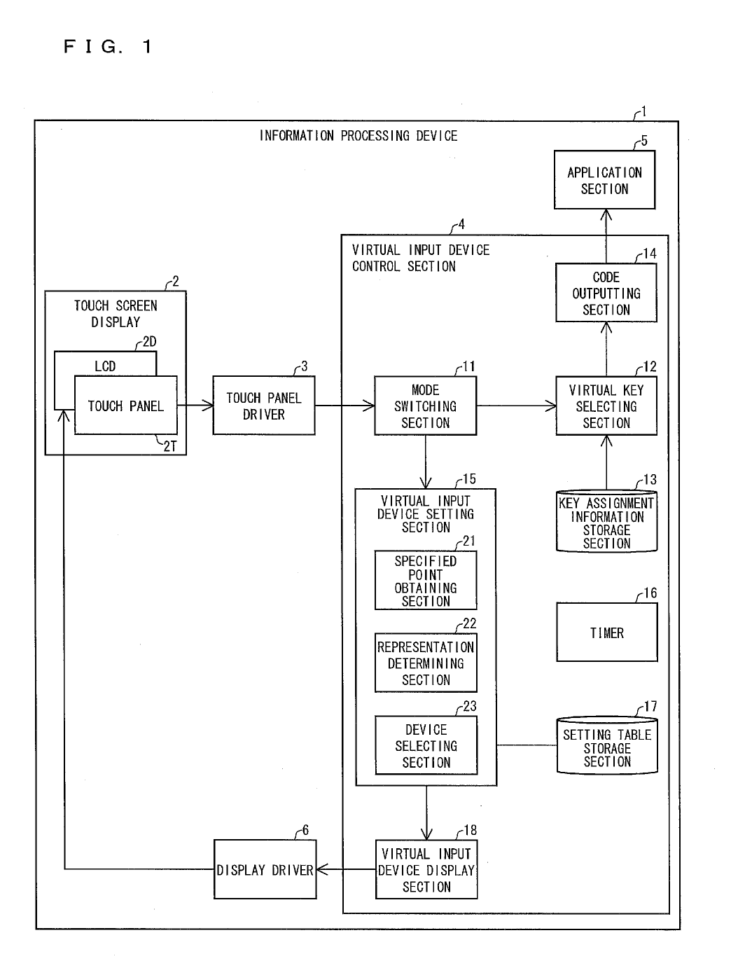

The following description will discuss an embodiment of the present invention in detail with reference to FIGS. 1 through 18.

[Overview of Information Processing Device]

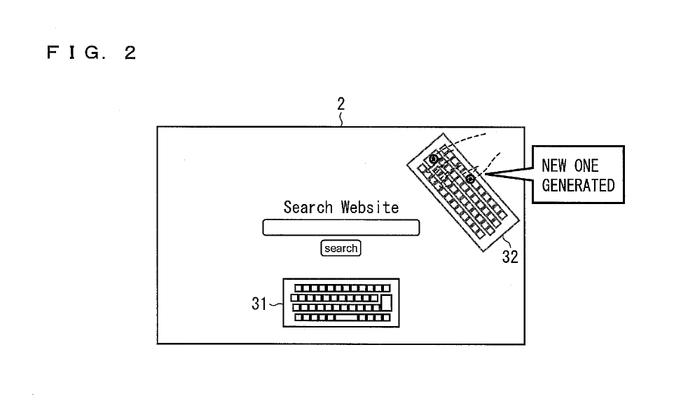

FIG. 2 illustrates an external appearance of a touch screen display 2 included in an information processing device 1 in accordance with the embodiment of the present invention.

The information processing device 1 at least includes the touch screen display 2, and causes the touch screen display 2 to display a virtual input device such as a virtual keyboard 31, a virtual keyboard 32, and the like via which a user carries out an input operation. Note that, according to the present embodiment, virtual keyboards displayed on the touch screen display 2 may be distinguished from each other by (i) referring to an already generated virtual keyboard as a virtual keyboard 31 and (ii) referring to a virtual keyboard to be newly generated as a virtual keyboard 32.

The touch screen display 2 of the information processing device 1 is realized by an LCD 2D and a touch panel 2T which are arranged such that the transparent touch panel 2T (FIG. 1) is provided on a display surface of the LCD (liquid crystal display device) 2D (FIG. 1). Examples of a detection method of the touch panel 2T encompass resistive film method and capacitive method. As a touch panel 2T, a multi-touch panel, which is capable of simultaneously detecting a plurality of touch locations, can be used.

The touch screen display 2 is configured such that the touch panel 2T is capable of detecting a touch location on a display screen of the LCD 2D, which touch location has been touched by a pen or a finger of a user. Coordinate data, which indicates a touch location on the display screen, is supplied from the touch screen display 2 to a processing section (described later) included in the information processing device 1. This allows the user to select, by using a finger, a pen, or the like, from various objects (such as an icon representative of a folder or a file, a menu, a button(s), and the like) displayed on the display screen of the LCD 2D.

According to the present embodiment, the touch screen display 2 is capable of displaying a virtual keyboard 31 (also referred to as software keyboard) as illustrated in FIG. 2. The virtual keyboard 31 includes a plurality of virtual keys (also referred to as software buttons) via which respective key codes are to be inputted. More specifically, examples of the virtual keys encompass numeric keys, alphabet keys, arrow keys, function key(s), and other supplemental keys. By touching (via the touch panel 2T) the virtual keys of the virtual keyboard 31 displayed on the LCD 2D, the user can input various code data (such as key code, character code, command, or the like) into an application window or the like displayed on the LCD 2D.

The information processing device 1 is also configured such that a plurality of users can simultaneously operate the touch screen display 2 from respective directions. That is, the plurality of users can cause virtual keyboards 31 and 32 to be generated and displayed on the touch screen display 2 according to sizes and directions of respective hands of the users. Specifically, while a first user is using his/her own virtual keyboard 31 displayed on the touch screen display 2, a second user can cause his/her own virtual keyboard 32 to be generated and displayed on the touch screen display 2. The virtual keyboards 31 and 32 can each be changed in size, direction, and/or location after being displayed.

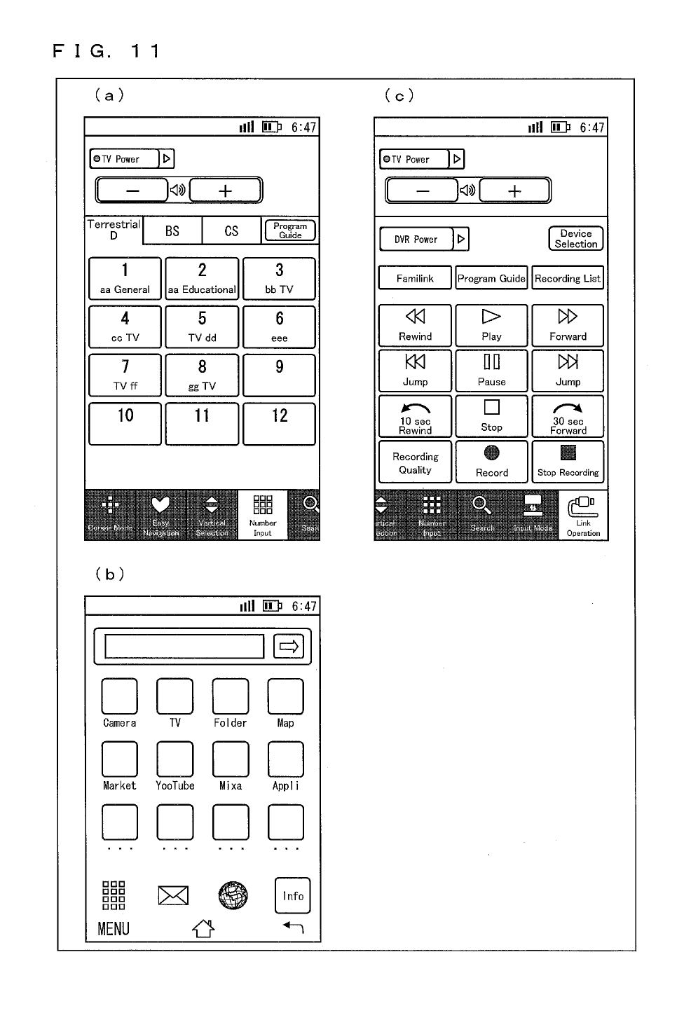

In addition to the virtual keyboard, other examples of the virtual input device to be displayed on the touch screen display 2 encompass, but are not limited to, a virtual numeric keypad and a virtual touch pad. In fact, any virtual input device can be used, provided that a representation, such as size, of the virtual input device is changeable on the touch screen display 2 for each user. A form of the virtual input device to be displayed on the touch screen display 2 can be a general form which is not limited to any applications, or can be an exclusive form to be used for a particular application. Specific examples of the virtual input device having an exclusive form encompass, but are not limited to, television remote control keys (see (a) of FIG. 11), a touch panel of a smartphone (see (b) of FIG. 11), and operations keys of a BD recorder (see (c) of FIG. 11).

A configuration of a system for causing the touch screen display 2 to display a virtual input device will be described next with reference to FIG. 1. FIG. 1 is a functional diagram schematically illustrating a configuration of the information processing device 1.

[Configuration of Information Processing Device for Displaying Virtual Input Device]

As illustrated in FIG. 1, the information processing device 1 includes the touch screen display 2, a touch panel driver 3, a virtual input device control section 4, an application section 5, and a display driver 6.

As has been described, the touch screen display 2 includes the LCD (liquid crystal display device) 2D and the transparent touch panel 2T provided on the upper surface of the LCD 2D. The touch panel 2T supplies, to the touch panel driver 3, a touch detection signal indicating that a touch location of the user has been detected. The LCD 2D displays, via the display driver 6, a virtual input device such as an application image or a virtual keyboard 31 and/or 32.

Based on the touch detection signal supplied from the touch panel 2T, the touch panel driver 3 generates coordinate data (touch location detection information) indicative of the touch location on the touch screen display 2. Then, the touch panel driver 3 supplies the coordinate data to the virtual input device control section 4.

The application section 5 receives code data supplied from the virtual input device control section 4, and then processes the code data by use of a predetermined application.

At the controls of the virtual input device control section 4, the display driver 6 causes the LCD 2D of the touch screen display 2 to display a virtual input device such as a virtual keyboard 31 and/or 32. At the controls of the application section 5, the display driver 6 also causes the LCD 2D to display an application image.

The virtual input device control section 4 determines a representation, such as type, size, direction, location, and the like, of a virtual input device, and then causes, via the display driver 6, the LCD 2D to display the virtual input device.

Hence, the virtual input device control section 4 includes: a mode switching section 11, a virtual key selecting section 12, a key assignment information storage section 13, a code outputting section 14, a virtual input device setting section 15, a timer 16, a setting table storage section 17, and a virtual input device display section (virtual input device display section) 18.

The mode switching section 11 switches between processing modes of the virtual input device control section 4. In a case where a predetermined touch operation (described later) is carried out, the mode switching section 11 transitions from a normal mode to a function generation mode. During the normal mode, the mode switching section 11 supplies, to the virtual key selecting section 12, touch location detection information supplied from the touch panel driver 3. During the function generation mode, on the other hand, the mode switching section 11 supplies touch location detection information to the virtual input device setting section 15.

The virtual key selecting section 12 selects, from a plurality of virtual keys on the virtual keyboard 31, a virtual key that has been touched by the user. The virtual key selecting section 12 selects a virtual key by making reference to key assignment information stored in the key assignment information storage section 13, which reference is made in accordance with the touch location detection information indicative of a touch location.

The key assignment information storage section 13 stores key assignment information 13. The key assignment information contains, in advance, (i) respective regions of the touch screen display 2 where a plurality of virtual keys are to be displayed, that is, respective display regions of the virtual keys and (ii) correspondence between the display regions and respective pieces of code data to be outputted.

The code outputting section 14 supplies, to the application section 5, code data corresponding to the virtual key that has been selected by the virtual key selecting section 12.

The virtual input device setting section 15 generates a virtual input device such as a virtual keyboard 32, and changes a location, shape, and the like of the virtual keyboard. Note that the virtual input device setting section 15 may store setting information such that pieces of setting information, each of which indicates a location, shape, and the like of a virtual input device, are associated with respective users by using IDs or the like of the users who have generated respective virtual input devices or who have changed settings of respective virtual input devices.

Specifically, the virtual input device setting section 15 obtains two specified points P1 and P2 specified on the touch panel 2T. Then, the virtual input device setting section 15 determines a size, a location, and a direction of a virtual input device such as a virtual keyboard 32 so that two reference points K1 and K2, which are assigned to a virtual input device in advance, match the two specified points P1 and P2, respectively. In other words, the virtual input device setting section 15 determines the size of the virtual input device by extending/shrinking a distance between the reference points K1 and K2 of the virtual input device so that the distance matches a distance between the two specified points P1 and P2. This allows a virtual input device such as a virtual keyboard 32 having a user-friendly representation to be displayed on the touch screen display 2 by a simple operation.

Hence, the virtual input device setting section 15 includes a specified point obtaining section (specified point obtaining section) 21, a representation determining section (representation determining section) 22, and a device selecting section (device selecting section) 23.

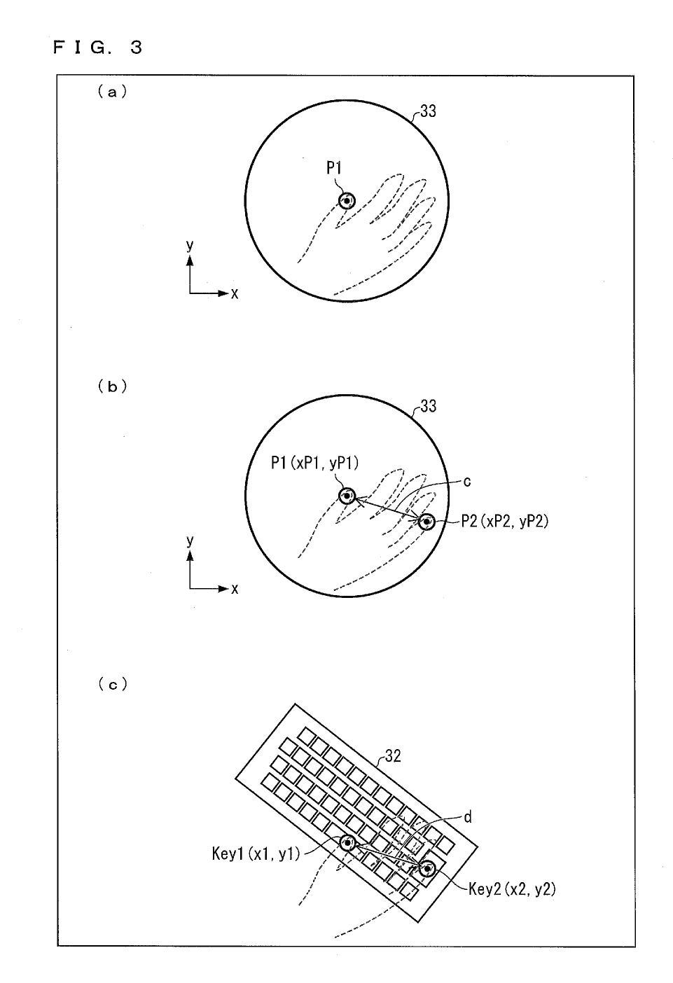

The specified point obtaining section 21 obtains two specified points P1 and P2 specified on the touch screen display 2 while a first specified point P1 specified first and a second specified point P2 specified second are distinguished from each other. Specifically, the specified point obtaining section 21 first obtains the first specified point P1, and then obtains the second specified point P2 in a case where any given location (to serve as a second specified point P2) is specified (i) during a predetermined period of time (input-enabled time t2) after the first specified point P1 is obtained, (ii) in a predetermined region (second specified point input region 33 (see (a) of FIG. 3)) of the touch screen display 2, which predetermined region is based on the first specified point P1, and (iii) for a predetermined period of time (held-down time t3).

The representation determining section 22 determines a size and a location of a virtual keyboard 32 on the touch screen display 2 such that two reference points K1 and K2, which are assigned to a virtual keyboard in advance, match the two specified points P1 and P2, respectively. The representation determining section 22 also determines a direction of the virtual keyboard 32 on the touch screen display 2 in accordance with the locations of the first specified point P1 and the second specified point P2 in relation to each other.

Specifically, (i) the two specified points P1 and P2 are distinguished from each other as a first specified point P1 specified first and as a second specified point P2 specified second in accordance with an order of an input operation and (ii) the two reference points K1 and K2 are distinguished from first specified point P1 and as a second reference point K2 corresponding to the second specified point P2. Then, the representation determining section 22 determines the size and the location as well as the direction of the virtual keyboard 32 by matching the first reference point K1 to the first specified point P1 and by matching the second reference point K2 to the second specified point P2.

The device selecting section 23 obtains the user's operation selecting, from a plurality of types of virtual input devices (virtual keyboard 32, virtual numeric keypad 41, and virtual touch pad 42) made available in advance, a virtual input device to be displayed on the touch screen display 2.

The timer 16 detects a touch time indicated by a touch signal which has been supplied to the mode switching section 11 and to the virtual input device setting section 15 and which is detected on the touch screen display 2. Specifically, the timer 16 is used for measuring a first held-down time t1, an input-enabled time t2, and a second held-down time t3. Note that a first held-down time t1, an input-enabled time t2, and a second held-down time t3 can each be set to any length.

The setting table storage section 17 stores a setting table to which the virtual input device setting section 15 refers. The setting table is set in advance such that different types of virtual input devices are associated with respective sets of locations of a first reference point K1 and of a second reference point K2.

A virtual input device display section 18 causes the touch screen display 2 to display the virtual keyboard 32 which is sized and located as determined by the representation determining section 22.

During the normal mode, the virtual input device control section 4 thus configured (i) receives touch location detection information, (ii) selects, in accordance with the touch location detection information, a virtual key, which has been touched by a user, from a plurality of virtual keys in a virtual keyboard 31, and (iii) supplies, to the application section 5, code data which is determined, based on key assignment information 13, to correspond to the touch location detection information. On the other hand, during the function generation mode, the virtual input device control section 4 thus configured (i) receives touch location detection information, (ii) determines, in accordance with the touch location detection information, a representation, such as type, size, direction, and location, of a virtual keyboard 32 to be displayed, and (iii) causes, via the display driver 6, the LCD 2D to display the virtual keyboard 32 having the representation thus determined.

[Overview of Method of Setting Virtual Keyboard]

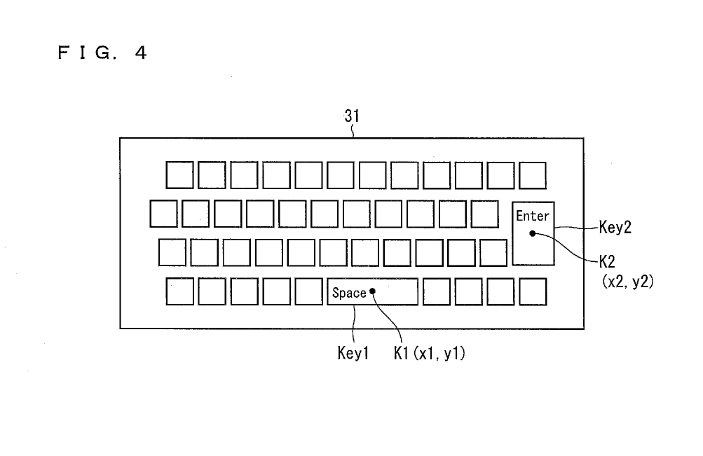

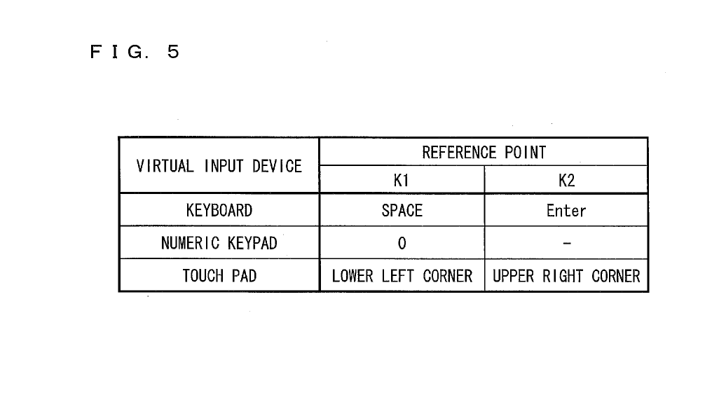

An overview of a method for displaying a virtual keyboard, which is sized, directed, and located in a user-friendly manner, will be described below with reference to FIGS. 3 through 5. FIG. 3 is an explanatory view schematically illustrating a method of setting a virtual keyboard. FIG. 4 is an explanatory view illustrating two reference points set for a virtual keyboard. FIG. 5 is a table illustrating a setting table stored in the setting table storage section 17.

As illustrated in (a) of FIG. 3, in a case where a given location on the touch screen display 2 is touched by a user's finger or the like for a predetermined period of time (first held-down time t1) or longer, (i) the given location is determined as a first specified point P1 and (ii) the touch screen display 2 displays a second specified point input region 33 that is a circle having the touch location as a center thereof.

Then, as illustrated in (b) of FIG. 3, in a case where a given location within the second specified point input region 33 thus displayed is touched by the user's another finger or the like for a predetermined period of time (second held-down time t3) or longer, the given location is determined as a second specified point P2. Then, a distance c between the first specified point P1 and the second specified point P2 is calculated. Then, a size of a virtual keyboard 32 is determined so that the distance c is identical to a distance d between a reference point K1 (e.g. center coordinates of a Key 1) and a second reference point (e.g. center coordinates of a Key 2) which are assigned to virtual keyboard in advance (see (c) of FIG. 3).

Note that the second specified point P2 can be inputted (i) only for a predetermined period of time (input-enabled time t2) after the first specified point P1 is inputted and (ii) only within the second specified point input region 33. This prevents an unwanted operation from occurring as a result of an operation of a user(s) other than the user attempting to set the virtual keyboard 32.

As illustrated in (b) and (c) of FIG. 3 and in FIG. 4, position coordinates (xP1, yP1) of the first specified point P1 correspond to the first reference point K1 (x1, y1) determined by the center coordinates of the Key 1 of the virtual keyboard. Position coordinates (xP2, yP2) of the second specified point P2 correspond to the second reference point K2 (x2, y2) determined by the center coordinates of the Key 2. Note that, as illustrated in (c) of FIG. 3 and in FIG. 5, for example, the first reference point K1 and the second reference point K2 can be set on the assumption that a right thumb of the user inputs the first specified point P1 whereas a right little finger of the user inputs the second specified point P2. Or, it is also possible to allocate the first reference point K1 to the center coordinates of a space key (Key 1) while allocating the second reference point K2 to an enter key (Key 2). Note, however, that respective locations of the two reference points K1 and K2 on the virtual keyboard and methods of inputting the two specified points P1 and P2 are not limited to those described above, but can be determined in any manner.

[Overview of Method of Changing Setting of Virtual Keyboard]

A method of changing a direction, size, and location of a virtual keyboard 31 displayed on the touch screen display 2 will be described next.

In a case where a user simultaneously touches a Key 1 region and a Key 2 region of a virtual keyboard 31 on the touch screen display 2 for a predetermined period of time (change initiating held-down time ts) or longer, a point specified by center coordinates of a finger or the like (operating body) touching the Key 1 and a point specified by center coordinates of a finger or the like (operating body) touching the Key 2 are obtained as a first specified point P1 and as a second specified point P2, respectively. In so doing, the point specified by the center coordinates of the finger or the like touching the Key 1 is designated as the first specified point P1 in accordance with FIG. 5 whereas the point specified by the center coordinates of the finger or the like touching the Key 2 is designated as the second specified point P2 in accordance with FIG. 5. Then, when the user moves the fingers or the like touching on the touch screen display 2, the specified points P1 and P2 move along. Then, when the specified points P1 and P2 stop for a predetermined period of time (change determining held-down time td) or longer, a direction, a size, and a location of a virtual keyboard 31 are determined based on respective locations of the specified points P1 and P2 as described in [Overview of Method of Setting Virtual Keyboard]. the change initiating held-down time is and the change determining held-down time td can each be set to any length.

[Detailed Flow in Method of Displaying Virtual Keyboard]

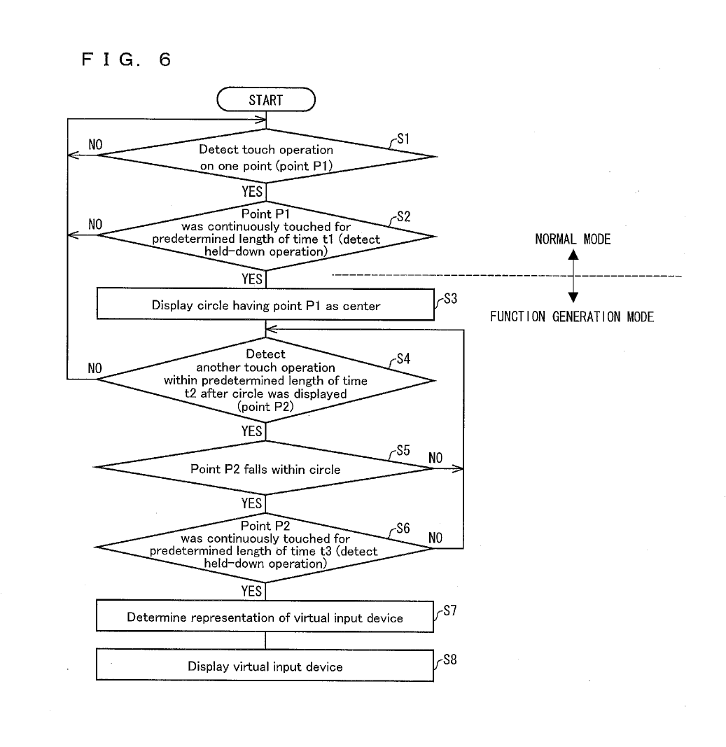

The following description will discuss, with referent to FIG. 6, a flow of a process in which the touch screen display 2 displays a virtual keyboard that is sized, directed, and located in a user-friendly manner. FIG. 6 is a flow chart illustrating a flow of a displaying process of a virtual input device.

First, the mode switching section 11 obtains touch location detection information indicative of position coordinates (xP1, yP1) of a touch location P1 detected on the touch screen display 2 (S1). Then, in a case where the mode switching section 11 obtains the touch location detection information (Yes in S1), the timer 16 measures a length of time for which a touch operation on the touch location P1 continues. In a case where the touch operation continues for a first held-down time t1 or longer (Yes in S2), (i) the touch location is determined as a first specified point P1 and (ii) a second specified point input region 33, which is a circle having a predetermined radius and having the touch location as a center thereof, is displayed on the touch screen display 2 (S3). On the other hand, in a case where the touch operation continues for less than the first held-down time t1 (No in S2), the process returns to the step S1.

Since the touch operation that continues for the first held-down time t1 or longer is thus detected, it is possible to prevent a virtual input device from being unintentionally displayed. In addition, by causing the second specified point input region 33 to be displayed as a circular image on the touch screen display 2, it is possible to notify the user (i) that switching has been made from the normal mode to the function generation mode, (ii) that inputting of the first specified point P1 has been completed, (iii) that a second specified point P2 can be inputted, and (iv) a region in which the second specified point P2 can be inputted.

Note that, in a case where the mode switching section 11 detected the touch operation as a held-down operation, the mode switching section 11 makes switching from the normal mode to the function generation mode, and supplies the touch location detection information to the virtual input device setting section 15. In other words, the mode switching section supplies position coordinates (xP1, yP1) of the touch location P1 to the specified point obtaining section 21 as described above. Then, the specified point obtaining section 21 designates the touch location P1 as a first specified point P1. The specified point obtaining section 21 causes the virtual input device display section 18 to cause, via the display driver 6, the touch screen display 2 to display a second specified point input region 33 having a predetermined radius and having the position coordinates (xP1, yP1) of the first specified point P1 as a center thereof. Then, in a case where a touch operation on any given location within the second specified point input region 33 is detected, touch location detection information on the touch operation is also supplied from the mode switching section 11 to the specified point obtaining section 21.

Next, after the virtual input device display section 18 causes the second specified point input region 33 to be displayed, the timer 16 measures a length of time which has passed after the second specified point input region 33 was displayed. Then, in a case where (i) the specified point obtaining section 21 obtains, within an input-enabled time t2 after the second specified point input region 33 was displayed, the touch location detection information indicative of position coordinates (xP2, yP2) of a touch location P2 detected on the touch screen display 2 (Yes in S4) and (ii) the touch location P2 falls within the second specified point input region 33 (Yes in S5), the timer 16 starts measuring a length of time for which the touch location P2 continues to be touched (S6). Then, in a case where the touch location P2 continues to be touched for a second held-down time t3 (Yes in S6), (i) the touch location P2 is designated as a second specified point P2 and (ii) a shape and the like of a virtual keyboard 32 are determined based on the first specified point P1 and the second specified point P2 (S7; representation determining step). Specifically, as described above, the representation determining section 22 determines a size and a location of the virtual keyboard 32 on the touch screen display 2 so that two reference points K1 and K2, which are assigned to the virtual keyboard in advance, match the two specified points P1 and P2, respectively. Then, in accordance with the size, the direction, and the location thus determined, the virtual input device display section 18 causes the virtual keyboard 32 to be displayed on the touch screen display 2 (S8; virtual input device displaying step). Note that the steps S1 through S6 correspond to a specified point obtaining step.

In contrast, in a case where the touch operation on the touch screen display 2 is not detected within the input-enabled time t2 after the second specified point input region 33 was displayed (No in S4), the specified point obtaining section 21 causes the virtual input device display section 18 to stop displaying the second specified point input region 33 on the touch screen display 2, and the process returns to the step S1. In a case where (i) the touch operation was detected outside and the touch location P2 was outside falls outside the second specified point input region 33 (No in S5) or (ii) the touch operation on the touch location P2 continues for less than the second held-down time t3 (No in S6), the process returns to the step S4, and detection of a new touch location P2 is then awaited.

Since the second specified point input region 33 is thus displayed for only the input-enabled time t2, it is possible to prevent a virtual input device from being unintentionally displayed. In addition, since the second specified point P2 can be inputted only within the second specified point input region 33, it is possible to prevent a virtual input device from being unintentionally displayed.

[Examples of Virtual Input Device Other Than Virtual Keyboard]

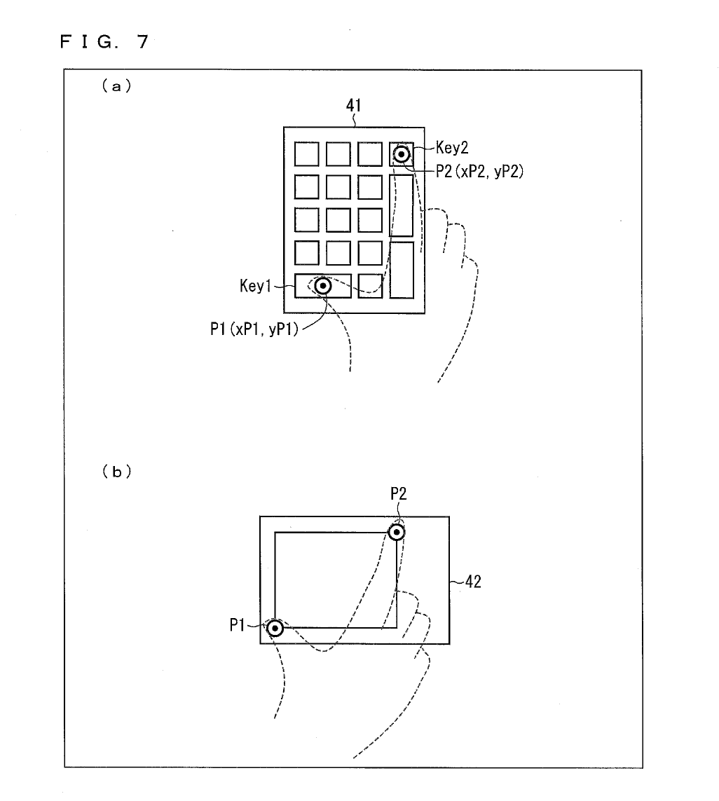

A virtual input device to be displayed on the touch screen display 2 is not limited to a virtual keyboard. A virtual numeric keypad and a virtual touch pad will be described below as examples of a virtual input device other than a virtual keyboard. FIG. 7 is an explanatory view illustrating virtual input devices other than a virtual keyboard, (a) of FIG. 7 illustrating a virtual numeric keypad and (b) of FIG. 7 illustrating a virtual touch pad.

According to a virtual numeric keypad 41, a first reference point K1 and a second reference point K2 are set on the assumption that a right thumb of a user inputs a first specified point P1 whereas a right index finger of the user inputs a second specified point P2 (see (a) of FIG. 7 and FIG. 5). Then, the first reference point K1 is allocated to center coordinates of a “0” key (Key 1) whereas the second reference point K2 is allocated to center coordinates of a “-” key (Key 2).

According to a virtual touch pad 42, a first reference point K1 and a second reference point K2 are set on the assumption that a right thumb of a user inputs a first specified point P1 whereas a right index finger of the user inputs a second specified point P2 (see (b) of FIG. 7 and FIG. 5). Then, the first reference point K1 is allocated to a lower left corner of a touch region whereas is allocated to an upper right corner of the touch region.

Note, however, a virtual input device to be displayed on the touch screen display 2 is not limited to a virtual keyboard, a virtual numeric keypad, or a virtual touch pad, but can be any virtual input device, provided that a representation, such as size, of the virtual input device on the touch screen display 2 can be changed for each user. Note also that respective locations of the two reference points K1 and K2 on the virtual input device and methods of inputting the two specified points P1 and P2 are not limited to those described above, but can be determined in any manner.

[Method of Selecting Virtual Input Device to be Displayed From a Plurality of Types of Virtual Input Devices]

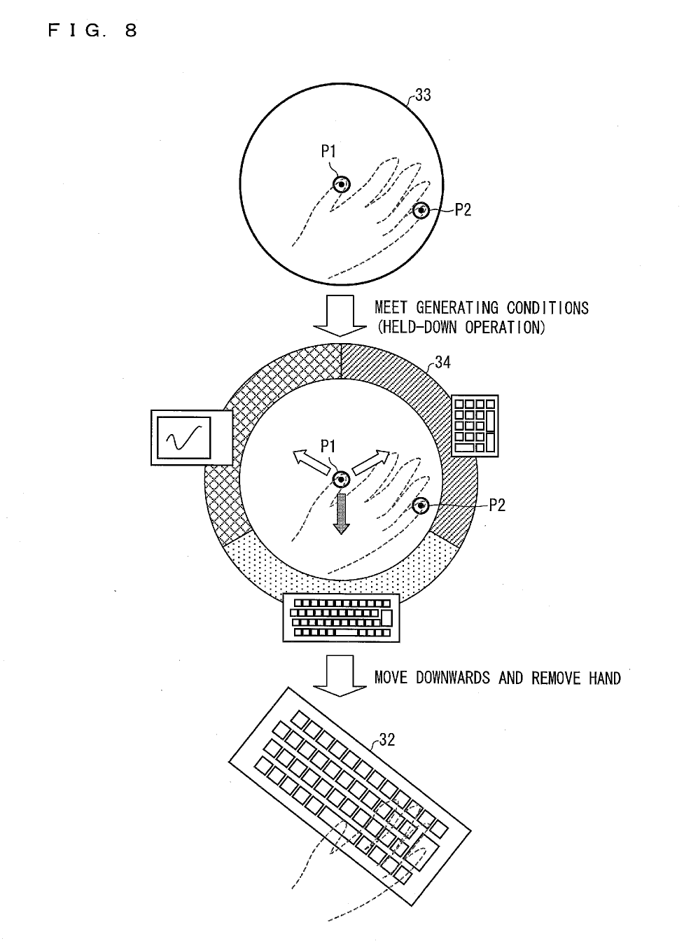

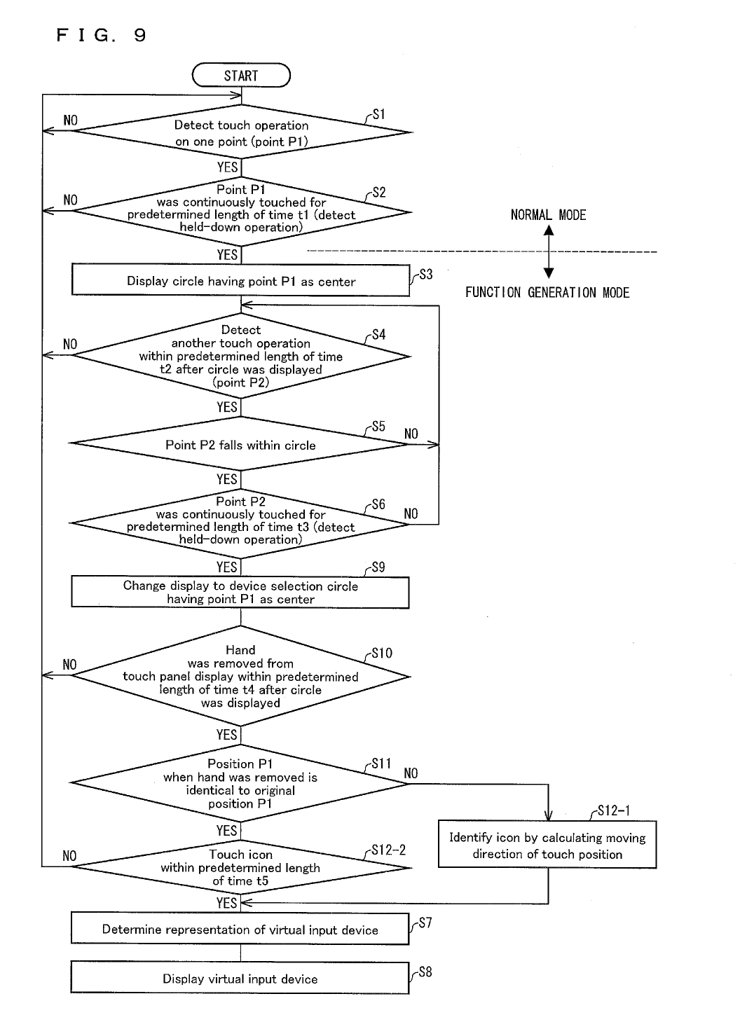

The following description will discuss, with reference to FIGS. 8 and 9, an overview of a method of selecting, from a plurality of types of virtual input devices, a virtual input device to be displayed. FIG. 8 is an explanatory view illustrating a method according to the information processing device 1 of selecting, from a plurality of types of virtual input devices, a virtual input device to be displayed. FIG. 9 is a flow chart illustrating a flow of a process according to the information processing device 1 of selecting, from a plurality of types of virtual input devices, a virtual input device to be displayed.

Steps S1 through S6 and steps S7 and S8 in the flow chart of FIG. 9 are similar to the steps S1 through S6 and steps S7 and S8 in the flow chart of FIG. 6 described in [Detailed Flow in Method of Displaying Virtual Keyboard]. Therefore, their descriptions will not be repeated below.

As illustrated in FIG. 9, in a case where conditions of the steps S1 through S6 are met, a device selecting section 23 causes, via the virtual input device display section 18, the touch screen display 2 to display a device selection circle 34 instead of the second specified point input region 33 (S9).

As illustrated in FIG. 8, the device selection circle 34 has, for example, a circular shape having a first specified point P1 as a center thereof. An entire circumference of the device selection circle 34 is divided into a number of segments, which number is equal to the number of selectable virtual input devices. The selectable virtual input devices are assigned to the respective segments. In a case where a user moves the first specified point P1 close to a segment while touching the first specified point P1, the user can select a virtual input device assigned to the segment to which the first specified point P1 was moved close. Alternatively, the user can select a virtual input device by selecting a segment of the device selection circle 34 or by selecting an icon of a virtual input device assigned to the segment. That is, examples of the method of selecting a type of virtual input device by using the device selection circle 34 encompass (i) a method in which a user moves the first specified point P1 toward a desired virtual input device while touching the first specified point P1 and (ii) a method in which the user once removes his/her finger or the like from the touch screen display 2 and then touches an icon of a desired virtual input device.

Specifically, the device selecting section 23 measures, by use of the timer 16, a length of time that has passed after the device selection circle 34 was displayed. In a case where the device selecting section 23 detects, within a predetermined period of time (first device selection time t4) after the device selection circle 34 was displayed, that the finger or the like of the user touching the first specified point P1 is removed from the touch screen display 2 (Yes in S10), it is determined whether or not position coordinates of the first specified point P1 when the finger or the like of the user is removed are identical to position coordinates of the first specified point P1 when the device selection circle 34 was displayed (S11).

Then, in a case where the position coordinates of the first specified point P1 have been changed when the finger of the like of the user is removed (No in S11), (i) a direction in which the touch location has been moved is calculated, (ii) it is determined which segment of the device selection circle 34 the first specified point P1 was moved close to, and (iii) it is determined which virtual input device has been selected (S12-1). In the example of FIG. 8, since the first specified point P1 is moved toward a lower part of the device selection circle 34 illustrated, it is determined that the user has selected a virtual keyboard that is assigned to a segment at a location toward which the first specified point P1 was moved.

In a case where the position coordinates of the first specified point P1 have not been changed when the finger or the like of the user is removed (Yes in S11), an operation to select a segment of the device selection circle 34 or to select an icon of a virtual input device assigned to the segment is obtained within a predetermined period of time (second device selection time t5), so that it is determined which virtual input device has been selected (S12-2).

Then, based on the first specified point P1 obtained in the step S2 and on a result of the step S6, the representation determining section 22 determines a shape and the like of the virtual input device such as a virtual keyboard 32 (S7; representation determining step). Then, the virtual input device display section 18 causes the touch screen display 2 to display a selected virtual input device which is sized, directed, and located as determined (S8; virtual input device displaying step).

In contrast, in a case where (i) the device selecting section 23 does not detect, within the first device selection time t4 after the device selection circle 34 was displayed, that the finger or the like of the user touching the first specified point P1 is removed from the touch screen display 2 (No in S10) or (ii) an operation to select the icon of the virtual input device of the device selection circle 34 is not carried out within the second device selection time t5 (No in S12-2), the process returns to the step S1.

Note that the first device selection time t4 and the second device selection time t5 can each be set to any length.

[Display Pattern of Virtual Keyboard]

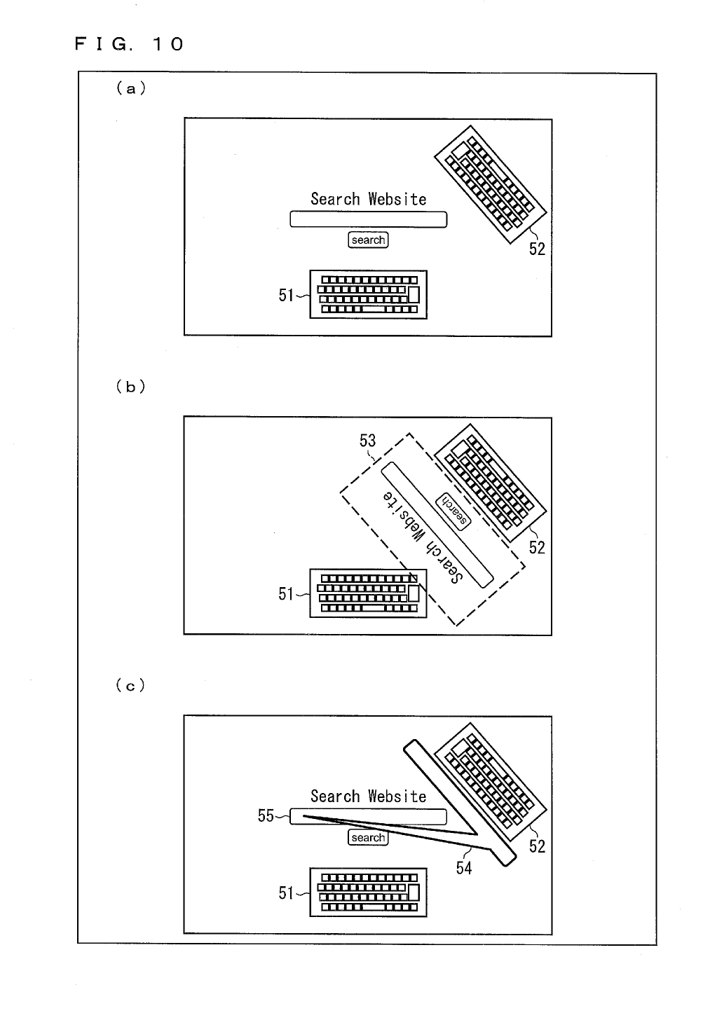

Next, the following description will discuss, with reference to FIG. 10, examples of a display pattern of a virtual keyboard. (a) through (c) of FIG. 10 are each an explanatory view illustrating a pattern of an application image while a virtual keyboard is displayed. Note that the following examples each assume that inputting of a character(s) into the application image is managed so that a plurality of virtual keyboards 51 and 52 are independent of each other. That is, when inputting of a character(s) via the virtual keyboard 52 is initiated, inputting of a character(s) via the keyboard 51, via which inputting of a character(s) was possible, is no longer possible. Furthermore, it is also possible to prevent a new virtual keyboard 52 from being generated while a character(s) is being inputted via an existing virtual keyboard 51.

As illustrated in (a) of FIG. 10, when inputting of a character(s) via a virtual keyboard 52 is initiated, the virtual input device display section 18 can fix a display image of an application section 5 on the touch screen display 2 without a change. According to the example of (a) of FIG. 10, the display image of the application section 5 is displayed in accordance with a direction of the virtual keyboard 51.

As illustrated in (b) of FIG. 10, when inputting of a character(s) via a virtual keyboard 52 is initiated, the virtual input device display section 18 can cause a display image of an application section 5 to be displayed in accordance with a location and a direction of the virtual keyboard 52 so that a user of the virtual keyboard 52 can easily view the display image of the application section 5. According to the example of (b) of FIG. 10, the display image 53 of the application section 5 is rotate, shrunk/enlarged, and displayed in the vicinity of the virtual keyboard 52.

Alternatively, as illustrated in (c) of FIG. 10, when inputting of a character(s) via a virtual keyboard 52 is initiated, the virtual input device display section 18 can display how a line of characters or the like inputted via the virtual keyboard 52 is being displayed within a display image of an application section 5. According to the example of (c) of FIG. 10, an input window 54 is displayed in accordance with a location and a direction of the virtual keyboard 52 so that a user of the virtual keyboard 52 can easily the display image of the input window 54. The input window 54 thus displayed has a balloon-like shape to make it recognizable that a line of characters or the like inputted into the input window 54 is inputted into an input box 55 of the application section 5.

(Modification 1) Exclusive Control of a Plurality of Displayed Virtual Keyboards

[Principles of Exclusive Control]

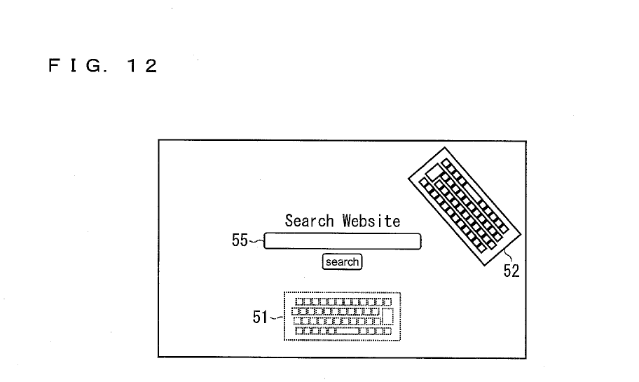

An example of exclusive control of a plurality of displayed virtual keyboards will be described next with reference to FIG. 12. Note that, for convenience, members similar in function to those described in the foregoing description of the embodiment will be given the same reference signs, and their description will be omitted.

FIG. 12 illustrates a virtual keyboard 51 and a virtual keyboard 52 displayed on a touch screen display 2 in accordance with Modification 1. Although FIG. 12 shows two virtual keyboards, the number of virtual keyboards is not particularly limited.

In Modification 1, “initiation of input” refers to a state in which (i) focus is on an input box 55 of a display image of an application section 5 and (ii) (a) one or more determined characters are inputted into the input box 55 or (b) an undetermined and temporary character(s) is displayed in the input box 55. An input state does not apply to a state in which a line of characters or the like inputted into the input box 55 via a given virtual keyboard has been entirely deleted by use of a delete key, a backspace key, or the like.

In a state in which focus is on the input box 55, a character(s) can be inputted via both the virtual keyboard 51 and the virtual keyboard 52 illustrated in (a) of FIG. 10. However, according to Modification 1, inputting of a character(s) via the virtual keyboard 51 becomes impossible when one character is inputted via the virtual keyboard 52. That is, the virtual keyboard 51 is subject to exclusive control. Then, inputting of a character(s) via the virtual keyboard 51, which did not allow inputting of a character(s), can become possible when a line of characters inputted into the input box 55 via the virtual keyboard 52 becomes undetermined by use of an enter key or the like.

For example, on a search website or the like, the input box 55 loses focus after inputting of a character(s) and searching are completed. In a case where a character(s) is inputted into the input box 55 again, users assign focus to the input box 55 by use of their respective mice or TAB keys of their respective keyboards. After focus is assigned to the input box 55, inputting of a character(s) becomes impossible via any virtual keyboard except for a keyboard via which a character(s) is inputted first.

[Displaying of Virtual Keyboard Subject to Exclusive Control]

Alternatively, displaying of a virtual keyboard 51 subject to exclusive control can be changed when the exclusive control is carried out (see FIG. 12). FIG. 12 illustrates, by dotted lines, the virtual keyboard 51 that is subject to the exclusive control. However, examples of a method of displaying a virtual keyboard subject to exclusive control encompass (i) a method in which the virtual keyboard is displayed in gray color and (ii) a method in which the virtual keyboard is displayed to have luminance lower than that of a virtual keyboard via which input of a character(s) is possible. Note that a method of displaying a virtual keyboard subject to exclusive control is not limited to any particular one, provided that the virtual keyboard subject to the exclusive control is distinguishable from a virtual keyboard via which inputting of a character(s) is possible.

Note that drawings for the descriptions of the other modifications also employ dotted lines to illustrate virtual keyboards subject to exclusive control. However, it is possible that (i) no virtual keyboards including those via which a character(s) is not being inputted are subject to exclusive control and (ii) all the virtual keyboards are displayed by use of solid lines.

Alternatively, a virtual keyboard subject to exclusive control can be configured such that only part of all keys prevents data input. Examples of such a key encompass keys relative to inputting of a character(s). Meanwhile, special keys, such as a function key irrelevant to inputting of a character(s), can allow inputting of a character(s). The virtual keyboard can be configured such that displaying of only keys via which inputting of a character(s) is impossible is changed as described above so that the keys are distinguishable from the other keys via which inputting of a character(s) is possible.

When inputting of a character(s) via a given virtual keyboard 52 is completed, exclusive control of other virtual keyboards 51 is removed. When the exclusive control is removed, the virtual keyboards 51, which were subject to the exclusive control, are then displayed as had been before being subject to the exclusive control.

With the configuration, it is possible for a user, who initiated inputting a character(s), to continue doing so without concern of being interrupted by other users. In addition, since displaying of the virtual keyboards 51 which were subject to exclusive control is changed, the users of such virtual keyboards 51 can recognize that the exclusive control has been removed. This makes it possible to smoothly prompt the users to input a character(s).

Alternatively, it is also possible that, while a given virtual keyboard 52 is used for inputting a character(s), other virtual keyboards 51 are not subject to exclusive control. With the configuration, inputting of a character(s) by a given user can be, during the inputting, aided by other users. In addition, since users are mindful of each other on a shared touch panel, inputting of a character(s) without disorderliness is possible.

(Modification 2) Control of Generation of a New Virtual Keyboard While a Character(s) is Being Inputted by an Existing Virtual Keyboard

An example of control of generation of a new virtual keyboard while a character(s) is being inputted by an existing virtual keyboard will be described next. Note that, for convenience, members similar in function to those described in the foregoing description of the embodiment and in Modification 1 will be given the same reference signs, and their description will be omitted.

In a case where, for example, a new virtual keyboard is generated while a character(s) is being inputted via a given virtual keyboard, an input box temporarily loses focus due to configurations of general applications and Operating Systems (OS). This causes users such trouble as returning focus to the input box.

According to Modification 2, as described above, no new virtual keyboard can be generated while a character(s) is being inputted via an existing virtual keyboard. According to the configuration, no new virtual keyboard can be generated while a character(s) is being inputted via a virtual keyboard. This prevents an input box from losing focus while a new virtual keyboard is generated, and therefore allows an improvement in operability of a user.

(Modification 3) Example of How an Image is Displayed During Inputting of Character(s) Via a Virtual Keyboard

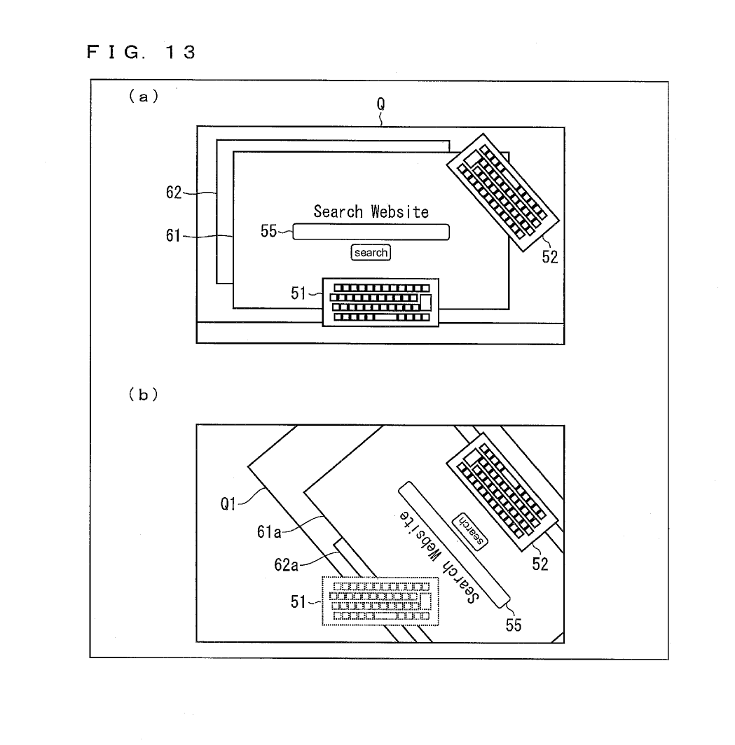

An example of how a virtual input device display section 18 displays an image while a character(s) is being inputted via a virtual keyboard will be described next with reference to FIGS. 13 through 16. Note that, for convenience, members similar in function to those described in the foregoing description of the embodiment, Modification 1, and Modification 2 will be given the same reference signs, and their description will be omitted.

### DISPLAY EXAMPLE 1

An example of how an image is displayed while a character(s) is being inputted via a virtual keyboard will be described below with reference to FIG. 13. Note that, for convenience, members similar in function to the those described in the foregoing description of the embodiment, Modification 1, and Modification 2 will be given the same reference signs, and their description will be omitted.

FIG. 13 illustrates a display image of Display Example 1 displayed on a touch screen display 2.

(a) of FIG. 13 shows an example of how the touch screen display 2 displays an image while no virtual keyboard is being used for inputting a character(s), that is, while all virtual keyboards are in a stand-by state.

As illustrated in (a) of FIG. 13, the touch screen display 2 displays (i) a virtual keyboard 51, (ii) a virtual keyboard 52, and (iii) a display image Q other than virtual keyboards. The display image Q includes (i) a window 61 including an input box 55 displayed by an application section 5, (ii) another window 62, and (iii) the like. The number of windows 62 including no input boxes 55 is not particularly limited.

(b) of FIG. 13 shows an example of how the touch screen display 2 displays an image while a character(s) is being inputted via a given virtual keyboard.

As illustrated in (b) of FIG. 13, when inputting of a character(s) via the virtual keyboard 52 is initiated, a display image Q is rotated in accordance with a location and a direction of the virtual keyboard 52 without changing a size of the display image. The display image is then designated as a display image Q1.

The display image Q1 includes a window 61a and a window 62a which are obtained by rotating, as was the display image Q1, a window 61 and a window 62, respectively. In the window 61a on the touch screen display 2, an entire region of an input box 55 is displayed. Inputting a character(s) via a virtual keyboard is a temporary action. Therefore, if part of the display image Q where the window 61a is included falls outside a display region of the touch screen display 2 or overlaps the virtual keyboard 51 and/or 52 so as to be invisible, it is still not problematic as long as the entire portion of the input box 55 is displayed.

With the configuration, the input box 55 can be displayed so as to be easily viewed by a user who is inputting a character(s).

### DISPLAY EXAMPLE 2

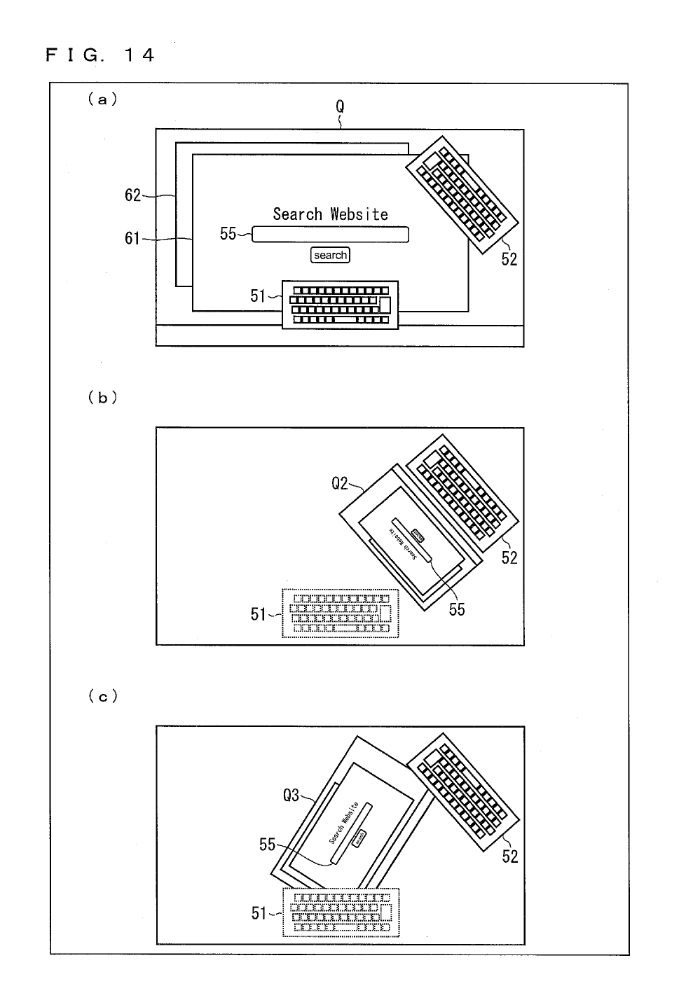

Another example of how an image is displayed while a character(s) is being inputted via a virtual keyboard will be described next with reference to FIG. 14.

FIG. 14 illustrates a display image of Display Example 2 displayed on a touch screen display 2.

(a) of FIG. 14 shows an example of how the touch screen display 2 displays an image while it is not determined via which virtual keyboard a character(s) is to be inputted.

As illustrated in (a) of FIG. 14, the touch screen display 2 displays (i) a virtual keyboard 51, (ii) a virtual keyboard 52, and (iii) a display image Q other than virtual keyboards. The display image Q includes (i) a window 61 including an input box 55 displayed by an application section 5, (ii) another window 62, and (iii) the like.

(b) of FIG. 14 shows an example of how the touch screen display 2 displays an image when inputting of a character(s) via a given virtual keyboard is initiated.

As illustrated in (b) of FIG. 14, when inputting of a character(s) via the virtual keyboard 52 is initiated, a display image Q is rotated and shrunk, so that an entire portion of the display image Q is displayed as a display image Q2 in the vicinity of the virtual keyboard 52.

The display image Q2 includes a window 61 and a window 62 which are obtained by rotating and shrinking, as was the display image Q1, the window 61 and the window 62, respectively.

With the configuration, a user of the virtual keyboard 52 can continuously carry out inputting of characters and subsequent tasks while easily viewing these tasks.

(c) of FIG. 14 shows another example of how the touch screen display 2 displays an image while a character(s) is being inputted via a given virtual keyboard.

In the example of (c) of FIG. 14, while a character(s) is being inputted via a given virtual keyboard 52, a display image k is rotated and shrunk so as to be displayed as a display image Q3. The display image Q3 is displayed at such a location that at least an input box 55 can be easily viewed by respective users of a virtual keyboard 51 and of the virtual keyboard 52. For example, the display image Q3 is displayed such that a direction and a location of the display image Q3 are obtained by working out averages of those of the virtual keyboard 51 and of the virtual keyboard 52. With the configuration, it is possible during inputting of a character(s), for both a user inputting the character(s) and a user not inputting the character(s) to easily view the screen.

### DISPLAY EXAMPLE 3

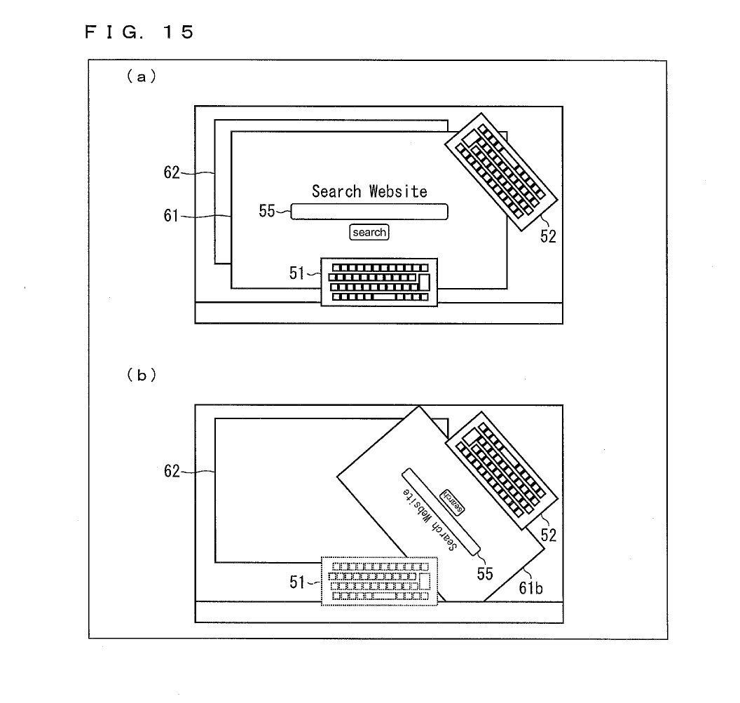

Another example of how an image is displayed while a character(s) is being inputted via a virtual keyboard will be described next with reference to FIG. 15.

FIG. 15 illustrates a display image of Display Example 3 displayed on a touch screen display 2.

(a) of FIG. 15 shows an example of how the touch screen display 2 displays an image while a virtual keyboard, via which a character(s) is to be inputted, is not determined.

As illustrated in (a) of FIG. 15, the touch screen display 2 displays (i) a virtual keyboard 51, (ii) a virtual keyboard 52, and (iii) a display image Q other than virtual keyboards. The display image Q includes (i) a window 61 including an input box 55 displayed by an application section 5, (ii) another window 62, and (iii) the like.

(b) of FIG. 15 shows an example of how the touch screen display 2 displays an image when inputting of a character(s) via a virtual keyboard is initiated.

As illustrated in (b) of FIG. 15, when inputting of a character(s) via a given virtual keyboard 52 is initiated, only a window 61, which is an active window allowing inputting of a character(s), is rotated and is displayed as a window 61b in front of the virtual keyboard 52. Note that the window 61b can be obtained by shrinking and rotating the window 61. If part of a display image Q where the window 61a is included falls outside a display region of the touch screen display 2 or overlaps the virtual keyboard 51 and/or 52 so as to be invisible, it is still not problematic as long as the entire portion of an input box 55 is displayed.

According to the configuration, in a case where a plurality of windows are displayed on the touch screen display 2, a location of only a window allowing inputting of a character(s) is changed whereas displaying of other windows irrelevant to inputting of a character(s) is not changed. Therefore, while a given user is inputting a character(s), all users can view, without any problem, an application(s) other than an active window allowing inputting of the character(s).

### DISPLAY EXAMPLE 4

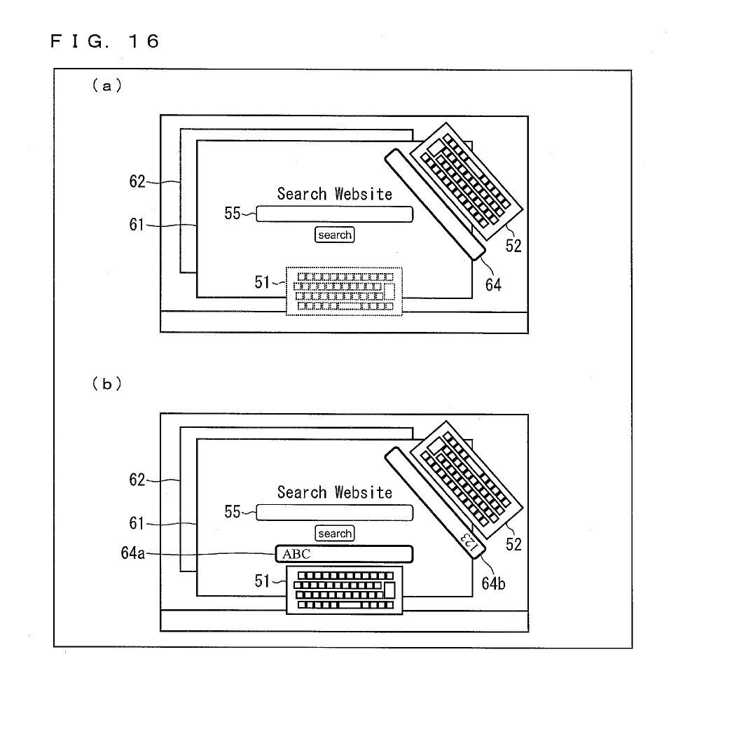

Another example of how an image is displayed while a character(s) is being inputted via a virtual keyboard will be described next with reference to FIG. 16.

FIG. 16 shows an example of an image of Display Example 4 displayed on a touch screen display 2 while a character(s) is being inputted via a given virtual keyboard.

The touch screen display 2 displays (i) a virtual keyboard 51, (ii) a virtual keyboard 52, (iii) a window 61 including an input box 55 displayed by an application section 5, (iv) another window 62, and (v) the like.

As illustrated in (a) of FIG. 16, while a character(s) is being inputted via a given virtual keyboard 52, an input window 64 is displayed in the vicinity of and to be adjacent to the virtual keyboard 52.

According to the configuration, a layout of an entire image is not changed. This allows all users to continuously view, without any problem, an input window on which a character(s) is to be inputted. Furthermore, a user inputting the character(s) can comfortably do so while viewing the character(s) inputted into the input window.

As illustrated in (b) of FIG. 16, it is possible to display input windows 64a and 64b in regions adjacent to virtual keyboards 51 and 52, respectively. According to this configuration in which input windows are displayed in respective regions adjacent to a plurality of virtual keyboards, virtual keyboards other than a virtual keyboard via which a character(s) is inputted can also be free from exclusive control. In such a case, the input windows 64a and 64b can allow inputting of characters independently of each other via the virtual keyboards 51 and 52, respectively. Then, when an Enter key or the like is pressed, a line of characters inputted on the input window 64a or 64b are transferred to an original input window.

(Modification 4) Examples of a Case Where a Display Image of an Application Includes a Plurality of Input Boxes Into Which a Line of Characters or the Like Can be Inputted Via a Virtual Keyboard

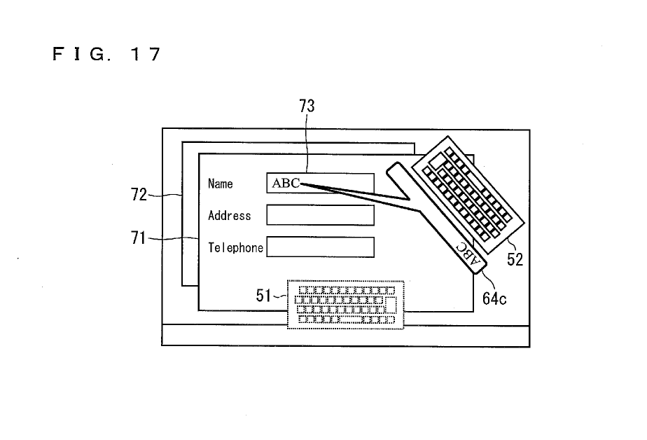

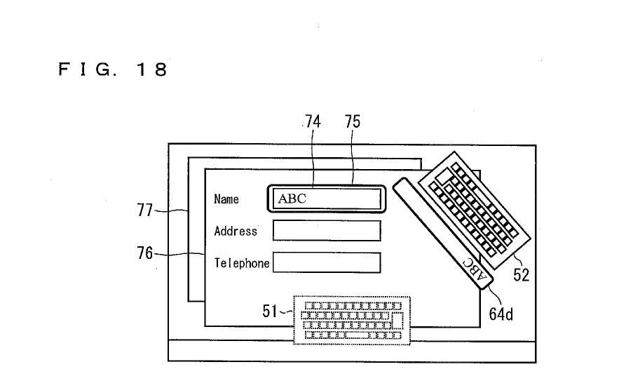

An example of how a line of characters or the like inputted via a virtual keyboard is displayed within a display image of an application section 5 by a virtual input device display section 18 will be described next with reference to FIGS. 17 and 18. Note that, for convenience, members similar in function to those described in the foregoing description of the embodiment, Modification 1, Modification 2, and Modification 3, will be given the same reference signs, and their description will be omitted.

FIG. 17 shows an example of a touch screen display 2 displays an image when inputting of a character(s) is initiated.

As illustrated in FIG. 17, the touch screen display 2 displays (i) a virtual keyboard 51, (ii) a virtual keyboard 52, (iii) a window 71 including a plurality of input boxes including an input box 73 which are displayed by an application section 5, (iv) another window 72, and (v) the like. Note that the number of windows 72 including no input boxes is not particularly limited. When inputting of a character(s) via a given virtual keyboard 52 is initiated, an input window 64c is displayed so as to be easily viewed by a user of the virtual keyboard 52. The input window 64c thus displayed has a balloon-like shape to make it recognizable that a line of characters or the like inputted on the input window 64c is inputted on an input window 73 which is one of a plurality of input windows displayed by the application section 5. Note that, as illustrated in FIG. 17, a tip of the balloon of the input window 64c preferably points to a position following a last one of the line of characters.

With the configuration, how a character(s) is inputted can be clearly shown while an input box displayed by the application section 5 is associated with a virtual keyboard. This allows a character(s) to be precisely inputted even in a case where a plurality of input boxes exist.

FIG. 18 shows another example of a touch screen display 2 displays an image when inputting of a character(s) is initiated.

As illustrated in FIG. 18, the touch screen display 2 displays (i) a virtual keyboard 51, (ii) a virtual keyboard 52, (iii) a window 76 including a plurality of input boxes including an input box 74 which are displayed by an application section 5, (iv) another window 77, and (v) the like. While a character(s) is being inputted via a given virtual keyboard 52, an input window 64d is displayed in a region adjacent to the virtual keyboard 52.

Then, a frame 75 is displayed around an input box 74 to make it recognizable that a line of characters or the like inputted on the input window 64d is inputted on the input box 74 which is one of a plurality of input boxes displayed by the application section 5. Unlike the input window 64c illustrated in FIG. 17, the frame 75 and the input window 64d share no continuous image such as a balloon.

With the configuration, there is no need to point, by use of a balloon or the like, from an input window displayed in front of a virtual keyboard to an input window within a window displayed by the application section 5. This eliminates a part of a displayed image, which part is hidden by the balloon or the like and therefore cannot be seen by users.

[Examples of Application]

The information processing device 1 has a wide range of application such as in information equipment including a touch screen display, example of which information equipment encompass a television receiver, a personal computer, an electronic whiteboard, a digital signage, a remote control device, a smartphone, a mobile phone, and a portable device. The information equipment including the information processing device 1 is also encompassed in the scope of the invention described herein.

[Additional Remarks]

The touch screen display of the information processing device 1 can be realized by, as described above, a configuration in which a transparent touch panel member is provided on a display surface of an LCD (liquid crystal display device). However, the touch screen display is not limited to such a configuration, but can be realized by a configuration in which part of touch sensor function is provided within pixels of an LCD, or is integrated with a color filter plate of an LCD main body.

As a final note, each block included in the information processing device 1, particularly the virtual input device control section 4, can be configured by a hardware logic or by software with the use of a CPU as detailed below.

In the latter case, the information processing device 1 includes a CPU that executes the instructions of a control program for realizing the aforesaid functions, ROM (Read Only Memory) that stores the control program, RAM (Random Access Memory) that develops the control program in executable form, and a storage device (storage medium), such as memory, that stores the control program and various types of data therein. With this arrangement, the object of the present invention is achieved by a computer (alternatively CPU or MPU) reading and executing the program stored in the storage medium. The storage medium stores, in computer-readable manner, program codes (executable code program, intermediate code program, and source program) of the control program of the information processing device 1, which program is software for realizing the aforesaid functions. The storage medium is provided to the information processing device 1.

The storage medium may be, for example, a tape, such as a magnetic tape and a cassette tape; a disk such as a magnetic disk including a floppy® disk and a hard disk and an optical disk including CD-ROM, MO, MD, DVD, and CD-R; a card, such as an IC card (including a memory card) and an optical card; or a semiconductor memory, such as a mask ROM, EPROM, EEPROM®, and flash ROM.

Further, the information processing device 1 may be arranged so as to be connectable to a communications network so that the program code is made available via the communications network. The communications network is not to be particularly limited. Examples of the communications network include the Internet, intranet, extranet, LAN, ISDN, VAN, CATV communications network, virtual private network, telephone network, mobile communications network, and satellite communications network. Further, a transmission medium that constitutes the communications network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared light, Bluetooth®, 802.11, HDR, mobile phone network, satellite connections, and terrestrial digital network. Note that the present invention can be also realized by the program codes in the form of a computer data signal embedded in a carrier wave which is embodied by electronic transmission.

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

The present invention can also be described as follows: In order to attain the object, an information processing device of the present invention includes: a touch screen display for displaying a virtual input device via which a user carries out an input operation; a specified point obtaining section for obtaining two specified points specified on the touch screen display; a representation determining section for determining a size and a location of the virtual input device on the touch screen display such that two reference points, which are assigned to the virtual input device in advance, match the respective two specified points thus obtained by the specified point obtaining section; and a virtual input device display section for causing the virtual input device having the size and the location thus determined by the representation determining section to be displayed on the touch screen display.

An information processing device control method of the present invention is a method of controlling an information processing device including: a touch screen display for displaying a virtual input device via which a user carries out an input operation, said method including the steps of: (a) obtaining two specified points specified on the touch screen display; (b) determining a size and a location of the virtual input device on the touch screen display such that two reference points, which are assigned to the virtual input device in advance, match the respective two specified points thus obtained in the step (a); and (c) causing the virtual input device having the size and the location thus determined in the step (b) to be displayed on the touch screen display.

According to the configuration, the information processing device obtains two specified points specified on the touch screen display, and determines a size and a location of a virtual input device on the touch screen display such that two reference points, which are assigned to the virtual input device in advance, match the respective two specified points. Then, the information processing device displays the virtual input device on the touch screen display in accordance with the size and the location thus determined.

Therefore, a location of a virtual input device to be displayed can be determined in accordance with locations of specified points. In addition, a size of a virtual input device to be displayed can be determined by determining a degree to which the virtual input device is to be enlarged/shrunk such that two reference points of the virtual input device match respective two specified points.

Therefore, when a user specifies two specified points on the touch screen display so as to cause a virtual input device, which is desirably located and sized, to be displayed, a virtual input device having such representation is displayed.

Therefore, the user can cause a virtual input device, which is located and sized in a user-friendly manner, to be displayed by such simple operation as specifying two specified points on a touch screen display.

The information processing device is further configured such that: the specified point obtaining section obtains the two specified points such that a first specified point specified first is distinguished from a second specified point specified second; and the representation determining section determines a direction of the virtual input device in accordance with how respective locations of the first specified point and of the second specified point are relative to each other.

According to the configuration, the information processing device obtains two specified points such that a first specified point specified first and a second specified point specified second are distinguished from each other. Then, the information processing device determines a direction of a virtual input device on the touch screen display in accordance with how respective locations of the first specified point and of the second specified point are relative to each other. Note that by distinguishing the two specified points from each other, the two specified points relative to each other in location can be determined as one factor. This allows the direction of the virtual input device on the touch screen display to be determined.

Therefore, in a case where a user inputs two specified points on the touch screen display, the user can specify a direction of a virtual input device to be displayed on the touch screen display by, for example, inputting a first specified point and then inputting a second specified point.

Hence, the user can cause a virtual input device, which is directed in a user-friendly manner, to be displayed by such simple operation as specifying two specified points on a touch screen display independently of each other.

The information processing device is further configured such that, in a case where, after the specified point obtaining section obtains the first specified point, a location falling within a predetermined region of the touch screen display, which predetermined region is based on the first specified point obtained first, continues to be specified for a predetermined period of time after the first specified point is obtained, the specified point obtaining section obtains the location as the second specified point.

According to the configuration, in a case where a location falling within a predetermined region of the touch screen display, which predetermined region is based on the first specified point obtained first, continues to be specified for a predetermined period of time after the first specified point is obtained, the specified point obtaining section obtains the location as the second specified point. In other words, the information processing device detects the second specified point in connection with a held-down operation within a limited region. Note that the “predetermined region” is preferably set to be located and shaped so that only a user inputting the two specified points on the touch screen display can operate the touch screen display. In addition, the “predetermined period of time” is preferably set to a proper length to allow the user to indicate an intention to input the second specified point.

Therefore, it is possible that only an operation of a user, who is inputting the two specified points to display the virtual input device, is obtained as an operation to input the two specified points.

Hence, it is possible to detect an unintentional input operation of another user(s), and therefore to prevent a virtual input device from being unintentionally displayed.

The information processing device is further configured such that an entire representation or a partial representation of one or a plurality of images, which is/are displayed on the touch screen display while the virtual input device is displayed on the touch screen display, is changed in accordance with how the virtual input device is displayed.

With the configuration, an image(s) displayed while a virtual input device is being displayed can be displayed so as to be easily viewed by a user. In addition, while a character(s) is being inputted, users, who are not inputting the character(s), can easily view their respective images.

The information processing device is further configured such that, in a case where a plurality of the virtual input devices are being displayed on the touch screen display, none of the plurality of the virtual input devices except for one via which a user is carrying out an input operation allows other users to carry out input operations.

With the configuration, a user, who has initiated inputting of a character(s), can input the character(s) exclusively. In other words, the user can input the character(s) without concern of being interrupted by other users.

The information processing device further includes: a device selecting section for obtaining a user's operation to select, from a plurality of types of virtual input devices made available in advance, a virtual input device to be displayed on the touch screen display.

According to the configuration, the information processing device further obtains a user's operation to select, from a plurality of types of virtual input devices made available in advance, a virtual input device to be displayed on the touch screen display.

Therefore, a virtual input device can be displayed in accordance with selection of the user. Examples of the plurality of types of virtual input device encompass, but are not limited to, a virtual keyboard, a virtual numeric keypad, and a virtual touch pad. The virtual input device can be anything, provided that representation, such as size, of the virtual input device can be changed.

Hence, a user can select a desirable virtual input device from a plurality of types of virtual input device, and causes the virtual input device to be displayed.

An electronic whiteboard of the present invention includes the information processing device.

Therefore, it is possible to cause a virtual input device, which has a user-friendly representation, to be displayed on a screen (touch screen display) of the electronic whiteboard by simple operation.

A television receiver of the present invention includes the information processing device.

Therefore, it is possible to cause a virtual input device, which has a user-friendly representation, to be displayed on a screen (touch screen display) of the television receiver by simple operation.

A digital signage of the present invention includes the information processing device.

Therefore, it is possible to cause a virtual input device, which has a user-friendly representation, to be displayed on a screen (touch screen display) of the digital signage by simple operation.

The information processing device can also be realized by use of a computer. In such a case, the scope of the present invention also encompasses (i) a program for realizing the information processing device by the computer through controlling the computer to serve as each of the sections included in the information processing device and (ii) a computer-readable storage medium in which the program is stored.

### INDUSTRIAL APPLICABILITY

The present invention allows a virtual input device such as a virtual keyboard to be displayed in a user-friendly representation on a touch screen display by simple operation. Therefore, the present invention a wide range of use, such as in information equipment including a touch screen display, example of which information equipment encompass a television, a personal computer, an electronic whiteboard, a digital signage, a remote control device, a smartphone, a mobile phone, and a portable device.

### REFERENCE SIGNS LIST

1 Information processing device

2 Touch screen display

18 Virtual input device display section (virtual input device display section)

21 Specified point obtaining section (specified point obtaining section)

22 Representation determining section (representation determining section)

23 Device selecting section (device selecting section)

32 Virtual keyboard (virtual input device)

33 Second specified point input region

41 Virtual numeric keypad (virtual input device)

42 Virtual touch pad (virtual input device)

P1, P2 Specified point

K1, K2 Reference point

S1 through S6 Specified point obtaining step

S7 Representation determining step

S8 Virtual input device displaying step

1-12. (canceled)

13. An information processing device comprising:
a touch screen display for displaying a virtual input device via which a user carries out an input operation;
a specified point obtaining section for obtaining two specified points specified on the touch screen display;
a representation determining section for determining a size or a location of the virtual input device on the touch screen display in accordance with the two specified points thus obtained by the specified point obtaining section; and
a virtual input device display section for causing the virtual input device having the size or the location thus determined by the representation determining section to be displayed on the touch screen display,
in a case where, after the specified point obtaining section obtains a first specified point which is specified first, a location falling within a predetermined region of the touch screen display, which predetermined region is based on the first specified point obtained first, continues to be specified for a predetermined period of time after the first specified point is obtained, the specified point obtaining section obtains the location as a second specified point.

14. The information processing device as set forth in claim 13, wherein
the representation determining section determines a direction of the virtual input device in accordance with how respective locations of the first specified point and of the second specified point are relative to each other.

15. The information processing device as set forth in claim 13, wherein an entire representation or a partial representation of one or a plurality of images, which is/are displayed on the touch screen display while the virtual input device is displayed on the touch screen display, is changed in accordance with how the virtual input device is displayed.

16. The information processing device as set forth in claim 13, wherein, in a case where a plurality of the virtual input devices are being displayed on the touch screen display, none of the plurality of the virtual input devices except for one via which a user is carrying out an input operation allows other users to carry out input operations.

17. The information processing device as set forth claim 13, further comprising:
a device selecting section for obtaining a user's operation to select, from a plurality of types of virtual input devices made available in advance, a virtual input device to be displayed on the touch screen display.

18. The information processing device as set forth in claim 13, wherein the specified point obtaining section obtains the first specified point in a case where the first specified point, which is specified first, continues to be specified for a predetermined period of time or longer.

19. An electronic whiteboard comprising:
an information processing device recited in claim 13.

20. A television receiver comprising:
an information processing device recited in claim 13.

21. A digital signage comprising:
an information processing device recited in claim 13.

22. A method of controlling an information processing device,
said information processing device comprising:
a touch screen display for displaying a virtual input device via which a user carries out an input operation,
said method comprising the steps of:
(a) obtaining two specified points specified on the touch screen display;
(b) determining a size or a location of the virtual input device on the touch screen display in accordance with the two specified points thus obtained in the step (a); and
(c) causing the virtual input device having the size or the location thus determined in the step (b) to be displayed on the touch screen display,
in the step (a), in a case where, after a first specified point which is specified first is obtained first, a location falling within a predetermined region of the touch screen display, which predetermined region is based on the first specified point obtained first, continues to be specified for a predetermined period of time after the first specified point is obtained, the location being obtained as a second specified point.

23. A non-transitory computer-readable storage medium in which a program for controlling an information processing device recited in claim 13 to operate is stored, the program causing a computer to serve as each of the sections included in the information processing device.

24. An electronic whiteboard comprising:
an information processing device recited in claim 14.

25. An electronic whiteboard comprising:
an information processing device recited in claim 15.

26. An electronic whiteboard comprising:
an information processing device recited in claim 16.

27. A television receiver comprising:
an information processing device recited in claim 14.

28. A television receiver comprising:
an information processing device recited in claim 15.

29. A television receiver comprising:
an information processing device recited in claim 16.

30. A digital signage comprising:
an information processing device recited in claim 14.

31. A digital signage comprising:
an information processing device recited in claim 15.

32. A digital signage comprising:
an information processing device recited in claim 16.
